(19) United States
(12) Patent Application Publication
(10) Pub. No.: US 2017/0171572 A1
(43) Pub. Date: Jun. 15, 2017

(54) METHOD FOR PLAYING A VIDEO, ELECTRONIC DEVICE, STORAGE MEDIUM

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Senlin DONG, Tianjin (CN)

(21) Appl. No.: 15/247,868

(22) Filed: Aug. 25, 2016

Related U.S. Application Data
(63) Continuation of application No. PCT/CN2016/088959, filed on Jul. 6, 2016.

(30) Foreign Application Priority Data
Dec. 15, 2015 (CN) 201510953134.X

(51) Int. Cl. H04N 21/232; H04N 21/44; H04N 21/432; H04N 21/234; H04N 21/637

(52) U.S. Cl. CPC H04N 21/232; H04N 21/234; H04N 21/637; H04N 21/432; H04N 21/44

(57) ABSTRACT

Disclosures are a method for playing a video on a network video client and a method for playing a video using a local video player. The network video client can receive an instruction to play a video, transmit a request for searching for the video respectively to the network video server and the local video player, and receive respective search results; and if only the network video server locates the video, then the video will be retrieved from the network video server for playing, if only the local video player locates the video, then the local video player will be invoked to play the video, and if both the network video server and the network video client locate the video, then a mode selection window will be provided for a user to select a “network video client playing mode” or a “local video player playing mode”.

### CROSS REFERENCE TO RELATED APPLICATIONS

This application is a continuation of International Application No. PCT/CN2016/088959, filed on Jul. 6, 2016, which is based upon and claims priority to Chinese Patent Application No. 201510953134.X, filed with the Chinese Patent Office on Dec. 15, 2015 and entitled “Method for playing a video, video client, local player, and smart device”, which is hereby incorporated by reference in its entirety.

### TECHNICAL FIELD

The disclosure relates to the field of smart devices, and particularly to a method for playing a video, electronic device and storage medium.

### BACKGROUND

As the broadband and electronic technologies are developing, smart TV sets and other smart devices have become very popular, and it is very common for users to play videos on their smart devices, where a video is played on a smart device generally in two modes including one mode in which a video is retrieved from a network video server through a network video client of the smart device, and the other mode in which a video resource in a local storage space (e.g., a storage space in the smart device, a U-disk, a removable hard disk, etc.) is played using a local video player of the smart device. The inventors of the disclosure have identified during making of the disclosure that these two video playing modes are isolated from and independent of each other in that the network video client only searches for an online video, and the local video player only searches for a local video, so the two modes may not be combined with each other, thus resulting in the following problems:

If the user retrieves the video from the network video server through the network video client, then the video resource will be ignored even if it is present in the local storage space, thus wasting a broadband resource in vain, and even resulting in a network latency, which may degrading the experience of the user watching the video; and if the video is absent on the network video server, then the user may not get timely knowledge of the presence of the video in the local storage space, but may still spend time on searching for the video over the Internet using a browser, etc. if the user plays a video resource in the local storage space using the local video player, then the user can only search a limited number of fixed video resources in the local storage space for the video resource to be played.

### SUMMARY

An object of embodiments of the disclosure is to provide an innovative technical solution to playing of a video on a smart device.

According to a first aspect of the embodiments of the disclosure, there is provided a method for playing a video on a network video client, the method including the steps: receiving an instruction to play a video, and obtaining a video name from the instruction; transmitting a request for searching for the video respectively to a network video server and a local video player, wherein the request carries the video name; receiving search results returned by the network video server and the local video player; and retrieving the video from the network video server for playing, or invoking the local video player to play the video, according to the received search results.

According to a second aspect of the embodiments of the disclosure, there is provided electronic device, the electronic device including: at least one processor; and a memory communicably connected with the at least one processor for storing instructions executable by the at least one processor, wherein execution of the instructions by the at least one processor causes the at least one processor: to receive an instruction to play a video, and obtaining a video name from the instruction; to transmit a request for searching for the video respectively to a network video server and a local video player, wherein the request carries the video name; to receive search results returned by the network video server and the local video player; and to retrieve the video from the network video server for playing, or to invoke the local video player to play the video, according to the received search results.

According to a third aspect of the embodiments of the disclosure, there is provided a non-transitory computer-readable storage medium, the non-transitory computer-readable storage medium storing executable instructions that, when executed by an electronic device with a touch-sensitive display, cause the electronic device: to receive an instruction to play a video, and obtaining a video name from the instruction; to transmit a request for searching for the video respectively to a network video server and a local video player, wherein the request carries the video name; to receive search results returned by the network video server and the local video player; and to retrieve the video from the network video server for playing, or to invoke the local video player to play the video, according to the received search results.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 illustrates a flow chart of an implementation of a method for playing a video on a network video client in accordance with some embodiments.

FIG. 2 illustrates a flow chart of an implementation of another method for playing a video on a network video client in accordance with some embodiments.

FIG. 3 illustrates a flow chart of an implementation of a method for playing a video using a local video player in accordance with some embodiments.

FIG. 4 illustrates a principle block diagram of a structure in which a network video client, a local video player, and a smart device in accordance with some embodiments.

FIG. 5 illustrates a principle block diagram of a structure in which an electronic device in accordance with some embodiments.

### DETAILED DESCRIPTION

Various exemplary embodiments of the disclosure will be described below in details with reference to the drawings. It shall be noted that unless stated otherwise, relative arrangements of components and steps, numeral expressions, and values, which are set forth in these embodiments will not limit the scope of the disclosure.

The following description of at least one exemplary embodiment is merely illustrative indeed, but not intended to limit the disclosure and its applications or uses in any way.

Techniques, methods, and devices known to those skilled in the art may not be discussed in details, but shall be construed as a part of the specification if appropriate.

Any particular values throughout the examples illustrated and discussed here shall be constructed as merely illustrative, but not intended to be limiting. Accordingly there may be different values in other examples of the exemplary embodiments.

It shall be noted that like reference numerals and symbols will refer to like elements throughout the drawings, so if some element is defined in one of the drawings, then it will not be further discussed in subsequent drawings.

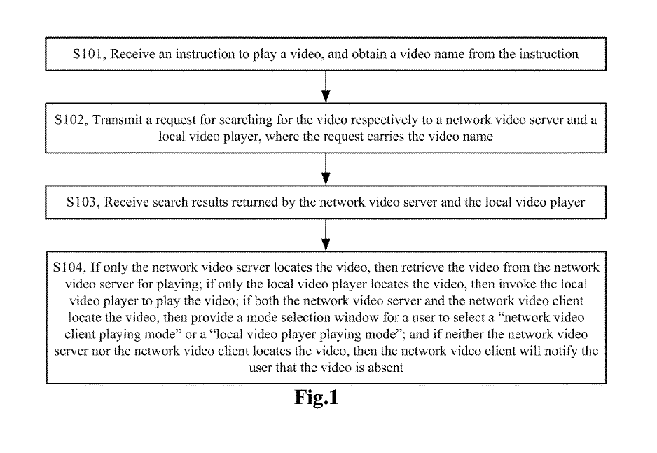

Referring to FIG. 1 illustrating a method for playing a video on a network video client according to a first embodiment of the disclosure, the system is arranged in a live broadcast backend.

S101. A network video client receives an instruction to play a video, and obtains a video name from the instruction.

S102. The network video client transmits a request for searching for the video respectively to a network video server and a local video player, where the request carries the video name.

S103. The network video client receives search results returned by the network video server and the local video player.

S104. This step may be performed in the following instances:

A1) If only the network video server locates the video, then the network video client will retrieve the video from the network video server for playing.

B1) If only the local video player locates the video, then the network video client will invoke the local video player to play the video.

C1) If both the network video server and the network video client locate the video, then the network video client will provide a mode selection window for a user to select a “network video client playing mode” or a “local video player playing mode”.

D1) If neither the network video server nor the network video client locates the video, then the network video client will notify the user that the video is absent.

Stated otherwise, the videos can be played on the network video client taking into account the videos played by the local player to thereby make full use of the video resources in the network video server and the local storage space so as to provide the user with more video resources.

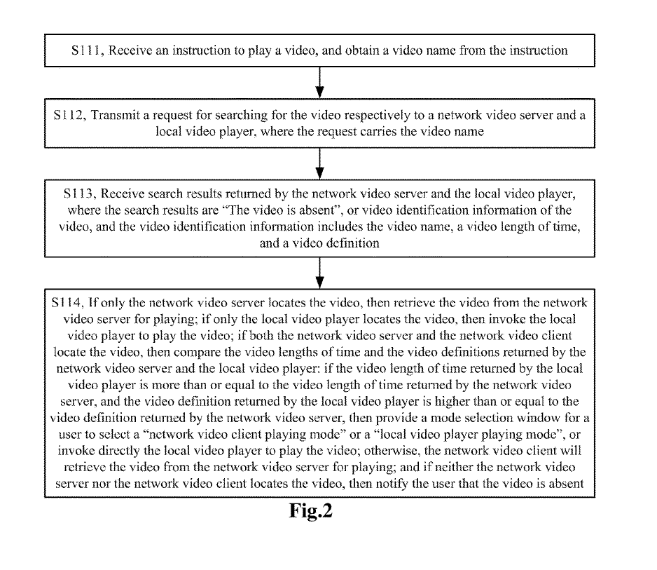

Referring to FIG. 2, another method for playing a video on a network video client according to an embodiment of the disclosure can include the following steps:

S111. The network video client receives an instruction to play a video, and obtains a video name from the instruction.

S112. The network video client transmits a request for searching for the video respectively to a network video server and a local video player, where the request carries the video name.

S113. The network video client receives search results returned by the network video server and the local video player, where the search results are “The video is absent”, or video identification information of the video, and the video identification information includes the video name, a video length of time, and a video definition.

S114. This step may be performed in the following instances:

A2) If only the network video server locates the video, then the network video client will retrieve the video from the network video server for playing.

B2) If only the local video player locates the video, then the network video client will invoke the local video player to play the video.

C2) If both the network video server and the network video client locate the video, then the network video client will compare the video lengths of time and the video definitions returned by the network video server and the local video player:

If the video length of time returned by the local video player is more than or equal to the video length of time returned by the network video server, and the video definition returned by the local video player is higher than or equal to the video definition returned by the network video server, then the network video client will provide a mode selection window for a user to select a “network video client playing mode” or a “local video player playing mode”, or invoke directly the local video player to play the video; otherwise, the network video client will retrieve the video from the network video server for playing.

D2) If neither the network video server nor the network video client locates the video, then the network video client will notify the user that the video is absent.

Stated otherwise, if the video is stored in both the network video server and the local video player, then if the video stored in the local video player is complete and has a higher definition, then the user will be enabled to select the “local video player playing mode”, or the local video player will be invoked directly to play the video; otherwise, the network video client will retrieve the video from the network video server for playing, so that the quality of playing the video can be maintained, and the experience of the watching the user can be guaranteed, while saving network resources as many as possible, and avoiding a network latency.

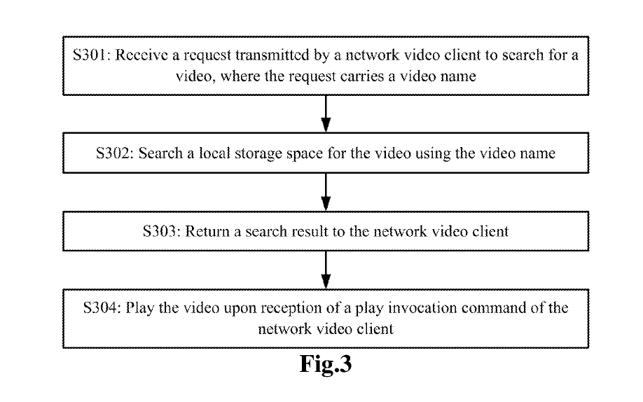

Referring to FIG. 3, a method for playing a video using a local video player according to an embodiment of the disclosure can include the followings steps:

S301 is to receive a request transmitted by a network video client to search for a video, where the request carries a video name.

S302 is to search a local storage space (e.g., a storage space in the smart device, a U-disk, a removable hard disk, etc.) for the video using the video name.

S303 is to return a search result to the network video client, where if the video is not located in the step S302, then the search result will be “the video is not located”, and if the video is located in the step S302, then the search result will be video identification information including the video name, a video length of time, and a video definition.

S304 is to play the video upon reception of a play invocation command of the network video client.

Stated otherwise, the videos can be played on the network video client taking into account the videos played by the local player to thereby make full use of the video resources in the network video server and the local storage space so as to provide the user with more video resources.

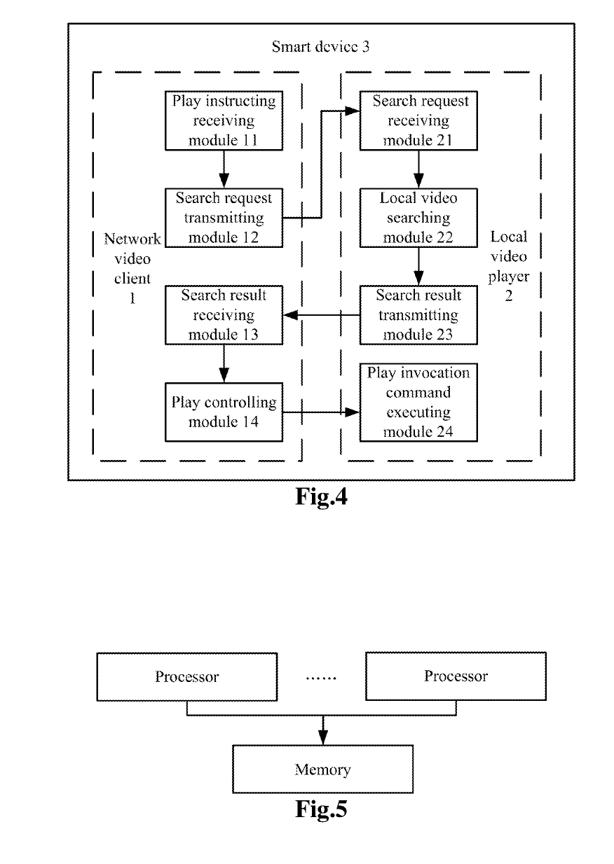

Referring to FIG. 4, a smart device according to an embodiment of the disclosure will be described.

The smart device 3 can include a network video client 1 and a local video player 2. The network video client 1 can include a play instruction receiving module 11, a search request transmitting module 12, a search result receiving module 13, and a play controlling module 14. The local video player 2 can include a search request receiving module 21, a local video searching module 22, a search result transmitting module 23, and a play invocation command executing module 24. The smart TV 3 can be a smart TV set, for example.

The play instruction receiving module 11 of the network video client 1 is configured to receive an instruction to play a video, and to obtain a video name from the instruction.

The search request transmitting module 12 of the network video client 1 is configured to transmit a request for searching for the video respectively to a network video server and the local video player 2, where the request carries the video name.

The network video server is configured to search the network video server for the video upon reception of the request transmitted by the network video client 1 to search for the video, and to return a search result to the network video client 1.

The search request receiving module 21 of the local video player 2 is configured to receive the request transmitted by the network video client 1 to search for the video.

The local video searching module 22 of the local video player 2 is configured to search a local storage space for the video using the video name.

The search result transmitting module 23 of the local video player 2 is configured to return a search result to the network video client 1.

The search result receiving module 13 of the network video client 1 is configured to receive the search results returned by the network video server and the local video player 2.

The play controlling module 14 of the network video client 1 is configured, if only the network video server locates the video, to retrieve the video from the network video server for playing; and if only the local video player 2 locates the video, to invoke the local video player 2 to play the video; and if both the network video server and the local video player 2 locate the video, to provide a mode selection window for a user to select a “network video client playing mode” or a “local video player playing mode”.

The play invocation instruction command executing module 24 of the local video player 2 is configured to play the video upon reception of a play invocation command of the network video client 1.

Stated otherwise, the smart device can play the videos on the network video client taking into account the videos played by the local player to thereby make full use of the video resources in the network video server and the local storage space so as to provide the user with more video resources.

Alternatively in another particular implementation of the embodiment of the disclosure.

The play instruction receiving module 11 of the network video client 1 is configured to receive an instruction to play a video, and to obtain a video name from the instruction.

The search request transmitting module 12 of the network video client 1 is configured to transmit a request for searching for the video respectively to a network video server and the local video player 2, where the request carries the video name.

The network video server is configured to search the network video server for the video upon reception of the request transmitted by the network video client 1 to search for the video, and to return a search result to the network video client 1.

The search request receiving module 21 of the local video player 2 is configured to receive the request transmitted by the network video client 1 to search for the video.

The local video searching module 22 of the local video player 2 is configured to search a local storage space for the video using the video name.

The search result transmitting module 23 of the local video player 2 is configured to return a search result to the network video client 1.

The search result receiving module 13 of the network video client 1 is configured to receive the search results returned by the network video server and the local video player 2, where the search results are “The video is absent”, or video identification information of the video, and the video identification information includes the video name, a video length of time, and a video definition.

The play controlling module 14 of the network video client 1 is configured, if only the network video server locates the video, to retrieve the video from the network video server for playing; if only the local video player 2 locates the video, to invoke the local video player 2 to play the video; and if both the network video server and the network video client 2 locate the video, to compare the video lengths of time and the video definitions returned by the network video server and the local video player 2: if the video length of time returned by the local video player 2 is more than or equal to the video length of time returned by the network video server, and the video definition returned by the local video player 2 is higher than or equal to the video definition returned by the network video server, to provide a mode selection window for a user to select a “network video client playing mode” or a “local video player playing mode”, or to invoke directly the local video player 2 to play the video; otherwise, to retrieve the video from the network video server for playing.

The play invocation instruction command executing module 24 of the local video player 2 is configured to play the video upon reception of a play invocation command of the network video client 1.

Stated otherwise, if the video is stored in both the network video server 1 and the local video player 2, then if the video stored in the local video player 2 is complete and has a higher definition, then the user will be enabled to select the “local video player playing mode”, or the local video player 2 will be invoked directly to play the video; otherwise, the network video client 1 will retrieve the video from the network video server for playing, so that the quality of playing the video can be maintained, and the experience of the watching the user can be guaranteed, while saving network resources as many as possible, and avoiding a network latency.

Referring to FIG. 4, a network video client according to an embodiment of the disclosure will be described:

The network video client 1 can include a play instruction receiving module 11, a search request transmitting module 12, a search result receiving module 13, and a play controlling module 14.

The play instruction receiving module 11 is configured to receive an instruction to play a video, and to obtain a video name from the instruction.

The search request transmitting module 12 is configured to transmit a request for searching for the video respectively to a network video server and the local video player, where the request carries the video name.

The search result receiving module 13 is configured to receive search results returned by the network video server and the local video player.

The play controlling module 14 is configured, if only the network video server locates the video, to retrieve the video from the network video server for playing; and if only the local video player locates the video, to invoke the local video player to play the video; and if both the network video server and the local video player locate the video, to provide a mode selection window for a user to select a “network video client playing mode” or a “local video player playing mode”.

Stated otherwise, the videos can be played on the network video client taking into account the videos played by the local player to thereby make full use of the video resources in the network video server and the local storage space so as to provide the user with more video resources.

Alternatively another network video client according to an embodiment of the disclosure includes:

A play instruction receiving module 11 is configured to receive an instruction to play a video, and to obtain a video name from the instruction.

A search request transmitting module 12 is configured to transmit a request for searching for the video respectively to a network video server and the local video player, where the request carries the video name.

A search result receiving module 13 is configured is configured to receive search results returned by the network video server and the local video player, where the search results are “The video is absent”, or video identification information of the video, and the video identification information includes the video name, a video length of time, and a video definition.

A play controlling module 14 is configured, if only the network video server locates the video, to retrieve the video from the network video server for playing; if only the local video player locates the video, to invoke the local video player to play the video; and if both the network video server and the network video client locate the video, to compare the video lengths of time and the video definitions returned by the network video server and the local video player: if the video length of time returned by the local video player is more than or equal to the video length of time returned by the network video server, and the video definition returned by the local video player is higher than or equal to the video definition returned by the network video server, to provide a mode selection window for a user to select a “network video client playing mode” or a “local video player playing mode”, or to invoke directly the local video player to play the video; otherwise, to retrieve the video from the network video server for playing.

Stated otherwise, if the video is stored in both the network video server and the local video player, then if the video stored in the local video player is complete and has a higher definition, then the user will be enabled to select the “local video player playing mode”, or the local video player will be invoked directly to play the video; otherwise, the network video client will retrieve the video from the network video server for playing, so that the quality of playing the video can be maintained, and the experience of the watching the user can be guaranteed, while saving network resources as many as possible, and avoiding a network latency.

Referring to FIG. 4, a local video player according to an embodiment of the disclosure will be described:

The local video player 2 can include a search request receiving module 21, a local video searching module 22, a search result transmitting module 23, and a play invocation command executing module 24.

The search request receiving module 21 is configured to receive a request transmitted by a network video client to search for the video, where the request carries a video name.

The local video searching module 22 is configured to search a local storage space for the video using the video name.

The search result transmitting module 23 is configured to return a search result to the network video client.

The play invocation instruction command executing module 24 is configured to play the video upon reception of a play invocation command of the network video client.

Stated otherwise, the videos can be played on the network video client taking into account the videos played by the local player to thereby make full use of the video resources in the network video server and the local storage space so as to provide the user with more video resources.

Referring to FIG. 5, an electronic device according to an embodiment of the disclosure will be described:

An electronic device, including: at least one processor; and a memory communicably connected with the at least one processor for storing instructions executable by the at least one processor, wherein execution of the instructions by the at least one processor causes the at least one processor:

to receive an instruction to play a video, and obtaining a video name from the instruction;

to transmit a request for searching for the video respectively to a network video server and a local video player, wherein the request carries the video name;

to receive search results returned by the network video server and the local video player; and

to retrieve the video from the network video server for playing, or to invoke the local video player to play the video, according to the received search results.

Where execution of the instructions by the at least one processor causes the at least one processor to retrieve the video from the network video server for playing, or to invoke the local video player to play the video, according to the received search results, further causes the at least one processor to:

if only the network video server locates the video, then to retrieve the video from the network video server for playing,

if only the local video player locates the video, then to invoke the local video player to play the video, and

if both the network video server and the network video client locate the video, then to provide a mode selection window for a user to select a “network video client playing mode” or a “local video player playing mode”.

Where execution of the instructions by the at least one processor causes the at least one processor, if both the network video server and the network video client locate the video, then providing a mode selection window for a user to select a “network video client playing mode” or a “local video player playing mode”, further causes the at least one processor:

if both the network video server and the network video client locate the video, then to compare the video lengths of time and the video definitions returned by the network video server and the local video player: if the video length of time returned by the local video player is more than or equal to the video length of time returned by the network video server, and the video definition returned by the local video player is higher than or equal to the video definition returned by the network video server, then to provide a mode selection window for a user to select a “network video client playing mode” or a “local video player playing mode”, or to invoke directly the local video player to play the video; otherwise, to retrieve the video from the network video server for playing.

Where the results returned by the local video player is obtained by searching a local storage space; wherein the local storage space comprising at least one of a storage space in a electronic device configured with the network video client, a U-disk, and a removable hard disk; and the results returned by the local video player comprising at least one of the video name, a video length of time, and a video definition.

A non-transitory computer-readable storage medium according to an embodiment of the disclosure will be described:

A non-transitory computer-readable storage medium storing executable instructions that, when executed by an electronic device with a touch-sensitive display, cause the electronic device:

to receive an instruction to play a video, and obtaining a video name from the instruction;

to transmit a request for searching for the video respectively to a network video server and a local video player, wherein the request carries the video name;

to receive search results returned by the network video server and the local video player; and

to retrieve the video from the network video server for playing, or to invoke the local video player to play the video, according to the received search results.

Where execution of the instructions by the electronic device causes the electronic device to retrieve the video from the network video server for playing, or to invoke the local video player to play the video, according to the received search results, further causes the electronic device to:

if only the network video server locates the video, then to retrieve the video from the network video server for playing,

if only the local video player locates the video, then to invoke the local video player to play the video, and

if both the network video server and the network video client locate the video, then to provide a mode selection window for a user to select a “network video client playing mode” or a “local video player playing mode”.

Where execution of the instructions by the electronic device causes the electronic device, if both the network video server and the network video client locate the video, then providing a mode selection window for a user to select a “network video client playing mode” or a “local video player playing mode”, further causes the electronic device:

if both the network video server and the network video client locate the video, then to compare the video lengths of time and the video definitions returned by the network video server and the local video player: if the video length of time returned by the local video player is more than or equal to the video length of time returned by the network video server, and the video definition returned by the local video player is higher than or equal to the video definition returned by the network video server, then to provide a mode selection window for a user to select a “network video client playing mode” or a “local video player playing mode”, or to invoke directly the local video player to play the video; otherwise, to retrieve the video from the network video server for playing.

Where the results returned by the local video player is obtained by searching a local storage space; where the local storage space comprising at least one of a storage space in a electronic device configured with the network video client, a U-disk, and a removable hard disk; and the results returned by the local video player comprising at least one of the video name, a video length of time, and a video definition.

The two modes in which the smart device plays a video in the prior art have their respective advantages and disadvantages, and the two play modes can be combined in the embodiments of the disclosure to thereby make full use the advantages thereof so that the user can make full use the video resources in the network video server and the local storage space. Preferably or optionally in the embodiments of the disclosure, the user can locate readily a better video resource. Preferably or optionally in the embodiments of the disclosure, the network bandwidth resources can be saved. Preferably or optionally in the embodiments of the disclosure, the operations by the user can be saved to thereby greatly improve the experience of the user.

Moreover if the video is stored in both the network video server and the local storage space, then if the video stored in the local storage space is complete and has a higher definition, then the user will be enabled to select the “local video player playing mode”, or the local video player will be invoked directly to play the video; otherwise, the network video client will retrieve the video from the network video server for playing, so that the quality of playing the video can be maintained, and the experience of the watching the user can be guaranteed, while saving network resources as many as possible, and avoiding a network latency.

The electronic device according to some embodiments of the disclosure can be in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

The embodiments of the apparatuses described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure.

The embodiments of the devices described above are only exemplary, in which the elements explained as separated parts may be or may not be separated physically and in which parts displayed as elements may be or may not be physical parts, i.e., they may be placed in one place or may be distributed on multiple network elements. The objects of this embodiment solution can be achieved by selecting the modules in part or in whole according to actual needs. It can be understood and implemented by those skilled in the art without paying creative labor.

Based on the descriptions of the abovementioned embodiments, it should be clearly understood by those skilled in the art that all the embodiments will be implemented via combination of software and a universal hardware platform and by hardware certainly. Based on such understanding, the aforesaid technical solution essentially or its part making a contribution to the prior art can be embodied in the form of software products and such computer software products may be stored in a computer readable storage medium, such as an ROM/RAM, a diskette and a light disk, and contain several instructions for enabling one set of computer equipment, which may be a PC, a server or network equipment, to execute the method described in each embodiment or in some part of the embodiments.

At last, it should be noted that the abovementioned embodiments are only used for illustrating but not limiting the technical solutions of this application. While this application has been described in detail herein with reference to the abovementioned embodiments, it should be understood by those skilled in art that they still may make changes to the technical solutions described in the embodiments or take equivalent replacements to part of technical features therein. These changes or replacements will not essentially depart the corresponding technical solutions from the spirit and scope of the technical solutions in all embodiments of this application.

What is claimed is:

1. A method for playing a video on a network video client, the method comprising the steps of:
receiving an instruction to play a video, and obtaining a video name from the instruction;
transmitting a request for searching for the video respectively to a network video server and a local video player, wherein the request carries the video name;
receiving search results returned by the network video server and the local video player; and
retrieving the video from the network video server for playing, or invoking the local video player to play the video, according to the received search results.

2. The method according to claim 1, wherein retrieving the video from the network video server for playing, or invoking the local video player to play the video, according to the received search results, comprises:
if only the network video server locates the video, then retrieving the video from the network video server for playing,
if only the local video player locates the video, then invoking the local video player to play the video, and
if both the network video server and the network video client locate the video, then providing a mode selection window for a user to select a “network video client playing mode” or a “local video player playing mode”.

3. The method according to claim 2, wherein if both the network video server and the network video client locate the video, then providing a mode selection window for a user to select a “network video client playing mode” or a “local video player playing mode”, comprises:
if both the network video server and the network video client locate the video, then comparing the video lengths of time and the video definitions returned by the network video server and the local video player: if the video length of time returned by the local video player is more than or equal to the video length of time returned by the network video server, and the video definition returned by the local video player is higher than or equal to the video definition returned by the network video server, then providing a mode selection window for a user to select a “network video client playing mode” or a “local video player playing mode”, or invoking directly the local video player to play the video; otherwise, retrieving the video from the network video server for playing.

4. The method according to claim 1, wherein the results returned by the local video player is obtained by searching a local storage space;
wherein the local storage space comprising at least one of a storage space in a electronic device configured with the network video client, a U-disk, and a removable hard disk; and the results returned by the local video player comprising at least one of the video name, a video length of time, and a video definition.

5. An electronic device, comprising:
at least one processor; and
a memory communicably connected with the at least one processor for storing instructions executable by the at least one processor, wherein execution of the instructions by the at least one processor causes the at least one processor:
to receive an instruction to play a video, and obtaining a video name from the instruction;
to transmit a request for searching for the video respectively to a network video server and a local video player, wherein the request carries the video name;
to receive search results returned by the network video server and the local video player; and
to retrieve the video from the network video server for playing, or to invoke the local video player to play the video, according to the received search results.

6. The electronic device according to claim 5, wherein execution of the instructions by the at least one processor causes the at least one processor to retrieve the video from the network video server for playing, or to invoke the local video player to play the video, according to the received search results, further causes the at least one processor to:
if only the network video server locates the video, then to retrieve the video from the network video server for playing,
if only the local video player locates the video, then to invoke the local video player to play the video, and
if both the network video server and the network video client locate the video, then to provide a mode selection window for a user to select a “network video client playing mode” or a “local video player playing mode”.

7. The electronic device according to claim 6, wherein execution of the instructions by the at least one processor causes the at least one processor, if both the network video server and the network video client locate the video, then providing a mode selection window for a user to select a “network video client playing mode” or a “local video player playing mode”, further causes the at least one processor:
if both the network video server and the network video client locate the video, then to compare the video lengths of time and the video definitions returned by the network video server and the local video player: if the video length of time returned by the local video player is more than or equal to the video length of time returned by the network video server, and the video definition returned by the local video player is higher than or equal to the video definition returned by the network video server, then to provide a mode selection window for a user to select a “network video client playing mode” or a “local video player playing mode”, or to invoke directly the local video player to play the video; otherwise, to retrieve the video from the network video server for playing.

8. The electronic device according to claim 5, wherein the results returned by the local video player is obtained by searching a local storage space;
wherein the local storage space comprising at least one of a storage space in a electronic device configured with the network video client, a U-disk, and a removable hard disk; and the results returned by the local video player comprising at least one of the video name, a video length of time, and a video definition.

9. A non-transitory computer-readable storage medium storing executable instructions that, when executed by an electronic device with a touch-sensitive display, cause the electronic device:
to receive an instruction to play a video, and obtaining a video name from the instruction;
to transmit a request for searching for the video respectively to a network video server and a local video player, wherein the request carries the video name;
to receive search results returned by the network video server and the local video player; and
to retrieve the video from the network video server for playing, or to invoke the local video player to play the video, according to the received search results.

10. The storage medium according to claim 9, wherein execution of the instructions by the electronic device causes the electronic device to retrieve the video from the network video server for playing, or to invoke the local video player to play the video, according to the received search results, further causes the electronic device to:
if only the network video server locates the video, then to retrieve the video from the network video server for playing,
if only the local video player locates the video, then to invoke the local video player to play the video, and
if both the network video server and the network video client locate the video, then to provide a mode selection window for a user to select a “network video client playing mode” or a “local video player playing mode”.

11. The storage medium according to claim 10, wherein execution of the instructions by the electronic device causes the electronic device, if both the network video server and the network video client locate the video, then providing a mode selection window for a user to select a “network video client playing mode” or a “local video player playing mode”, further causes the electronic device:
if both the network video server and the network video client locate the video, then to compare the video lengths of time and the video definitions returned by the network video server and the local video player: if the video length of time returned by the local video player is more than or equal to the video length of time returned by the network video server, and the video definition returned by the local video player is higher than or equal to the video definition returned by the network video server, then to provide a mode selection window for a user to select a “network video client playing mode” or a “local video player playing mode”, or to invoke directly the local video player to play the video; otherwise, to retrieve the video from the network video server for playing.

12. The storage medium according to claim 9, wherein the results returned by the local video player is obtained by searching a local storage space;
wherein the local storage space comprising at least one of a storage space in a electronic device configured with the network video client, a U-disk, and a removable hard disk; and the results returned by the local video player comprising at least one of the video name, a video length of time, and a video definition.
